(19) United States
(12) Patent Application Publication
(10) Pub. No.: US 2005/0270383 A1
(43) Pub. Date: Dec. 8, 2005

(54) Method for detecting and processing dominant color with automatic white balance

(75) Inventor: Kuo-Ching Hung, Taoyuan Shien (TW)

Correspondence Address: BRUCE H. TROXELL, SUITE 1404, 5205 LEESBURG PIKE, FALLS CHURCH, VA, 22041, US

(73) Assignee: AIPTEK International Inc.

(21) Appl. No.: 10/858,050

(22) Filed: Jun. 2, 2004

(51) Int. Cl. H04N 9/73

(52) U.S. Cl. 348/225.1

(57) ABSTRACT

A method for detecting and processing dominant color with automatic white balance, comprises the steps of: initiating an automatic white balance for a digital image; computing reference white points and presetting color temperature; making an evaluation to determining whether the amount of the reference white points is larger than a predefined percentage; gathering statistics for dominant colors; making an evaluation to determining whether a color patch belongs to the dominant color; performing AWB dominant color process; performing normal AVVB process; adjusting the gain values of blue light and red light; ending the AWB adjustment process. The method first detect the deviation of the reference white point to the color temperature and generate a curve of the same, and then uses a statistic method to determining the values of dominant colors, and compares the color value to-the color patches of a color checker chart for generating a C.T. deviation prediction curve according to each color patch so as to obtain the offset of each color, and uses the offset with respect to the corresponding C.T. deviation prediction curve to obtain a correct color temperature for adjusting the color to be the same as the color perceived by human eyes.

### FIELD OF THE INVENTION

The present invention relates to a method for detecting and processing dominant color with automatic white balance, and more particularly, to a method adapted for setting and processing automatic white balance of a digital camera.

### BACKGROUND OF THE INVENTION

Digital imaging systems are becoming increasingly popular. Especially the digital camera and the digital camcorder are the most prevalent goods among the products of the digital imaging industry. The reasons why the digital imaging products is well-liked by consumers are as following:

(1) Convenience: Most current digital imaging products have a built-in LCD monitor capable of display an image captured by the same in real time such that the quality of the captured imaged is realized immediately and conveniently without the trouble of having to develop films by a professional technician as a conventional camera.

(2) Cost-saving capability: The costs for viewing an image captured by a conventional camera includes: price of film, cost for developing the film, and cost for print the photography, which might amount to a small fortune. On the other hand, the digital camera stores images in the built-in memory or memory card capable of transferring the captured images to a storage media of person computer for viewing with almost no cost.

(3) Potential for improving photographic technique: Since the cost of taking pictures with a digital camera is very low, that is, it will cost only to recharge the battery of the digital camera and to purchase sufficient memory card for storing images, the photographer using a digital camera can practice on changing the settings, such as shutter speed, diaphragm, white balance and exposure compensation, etc., for seeking the best shooting parameters for the intended image without worrying the consequent expense, such that the photographer is able to gain precise photo experience and thus improve his photographic technique.

(4) Post-production ability: Do you ever get your film developed and realize that only half of the pictures turned out correctly and can not be remedied? With a digital camera, the photographer can view the picture immediately after its taken and perform some editorial post-production works on the captured image using some image processing software for bettering the photo to a real image or adding special effects to the photo.

Due to the aforementioned advantages, it is easy to understand the recent booming expansion of patent applications for the digital imaging products and the corresponding application software.

Most digital cameras feature automatic white balance (AWB). Setting white balance incorrectly may cause a color shift in the image. For example, suppose the camera is told to use a color temperature (C.T.) of sunlight to take an image of an indoor environment illuminated mainly by incandescent lights. The camera will expect excessive blue light and less red light, and set its algorithm to be more sensitive to the blue light. However, in an environment illuminated with incandescent lights, color temperature is low with excessive red light rather than the blue one. As a result, we shall see a reddish or yellowish image. A digital camera having a proper automatic white balance capability can be free from the trouble of having to perform a post-production process on a captured image. Therefore, digital camera manufacturers are all making every effort to improve its automatic white balance algorithm for having a “better” digital image product. Current white balance algorithms available on the market are as following:

(1) detecting and adjusting color temperature deviations using a fuzzy logic rules, which is provided by Yung-Cheng Liu, Wen-Hsin Chan and Ye-Quang Chen, “AUTOMATIC WHITE BALANCE FOR DIGITAL STILL CAMERA”, IEEE Transactions on Consumer Electrics, Vol. 41, No. 3, August 1995.

(2) detecting global white points for adjusting the image to be adjusted using percentile of frequency distribution according to U.S. Pat. No. 6,069,972, “GLOBAL WHITE POINT DETECTION AND WHITE BALANCE FOR COLOR IMAGE”.

(3) using infrared rays and ultraviolet rays to detect and adjust the color temperature of the image to be adjusted.

The conventional white balance algorithms as aforementioned use only standard reference white points for estimating and measuring color temperature which is prone to create color deviation caused by the dominant color of the image. In this regard, the present invention provides a color patch curve generated by a color checker chart of the invention to correct and adjust the foregoing deviation.

### SUMMARY OF THE INVENTION

The primary object of the invention is to provide a method for detecting and processing dominant color with automatic white balance that the method first uses an improve fuzzy and Gray World method to detect the deviation of the reference white point to the color temperature and generate a curve of the same, and then uses a statistic method to determining the values of dominant colors, and compares the color value to the color patches of a color checker chart for generating a C.T. deviation prediction curve according to each color patch so as to obtain the offset of each color, and uses the offset with respect to the corresponding C.T. deviation prediction curve to obtain a correct color temperature for adjusting the color to be the same as the color perceived by human eyes.

To achieve the above object, the method for detecting and processing dominant color with automatic white balance according to the present invention comprises the following steps:

initiating an automatic white balancing for a digital image;

computing reference white points and presetting color temperature;

making an evaluation to determining whether the amount of the reference white points is larger than a predefined percentage;

gathering statistics for dominant colors;

making an evaluation to determining whether a color patch belongs to the dominant color;

performing AWB dominant color process;

performing normal AWB process;

adjusting the gain values of blue light and red light; and

ending the AWB adjustment process.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a flow chart of a color process for a digital imaging device of the present invention.

FIG. 2 is a schematic view of a color checker chart according to the present invention.

FIG. 3A is a white point predictable curve of the present invention.

FIG. 3B is a flow chart of the FIG. 3A.

FIG. 4A a color patch curve of the present invention.

FIG. 4B is a flow chart of FIG. 4A.

FIG. 5 is a flow chart of an automatic white balance process of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

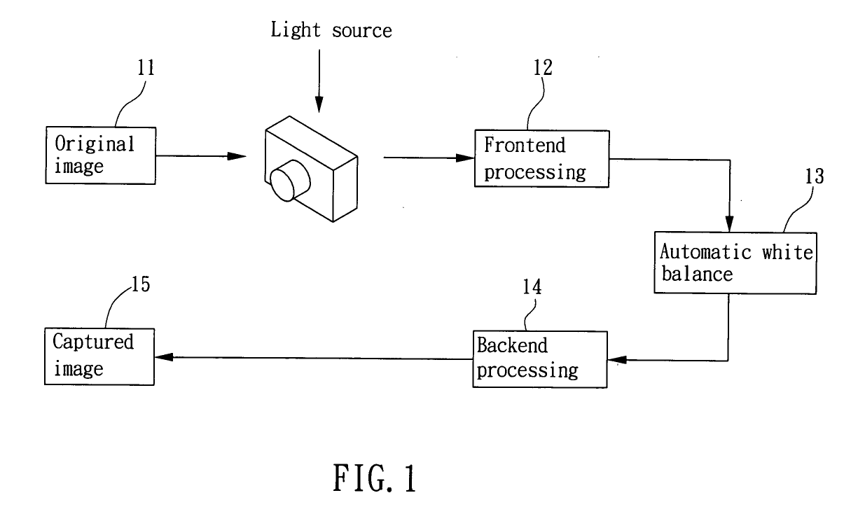

Please refer to FIG. 1, which is a flow chart of a color process for a digital imaging device of the present invention. Wherein, an original image 11 captured by built-in sensors of an digital imaging device under different illumination condition, such as under strong sunlight or in a room illuminated with incandescent lights, is presented with a color temperature differed from that of human eye since our eyes, with the help from the experience we learned, see a white paper as a white paper no matter it is viewed under strong sunlight or in a room illuminated with incandescent lights, and the original image is then processed by a frontend operation 12, followed by an automatic white balance adjustment 13 and a backend process 14 so as to obtain a captured image 15.

Color temperature is a measurement in Degrees Kelvin that indicates the hue of a specific type of light source. It is based on the ratio of the amount of blue light to the amount of red light, and the green light is ignored. The unit for measuring this ratio is in degree Kelvin (K). The standard white color temperature of the present invention is 4200K. A light with higher color temperature (i.e., larger Kelvin value), including 5000K and 6500K, has “more” blue lights than a light with lower color temperature (i.e., smaller Kelvin value), such as 2800K and 2300K. The present invention uses 2300K, 2800K, 4200K, 5000K and 6500K as measured points for acquiring the white point predictable curve.

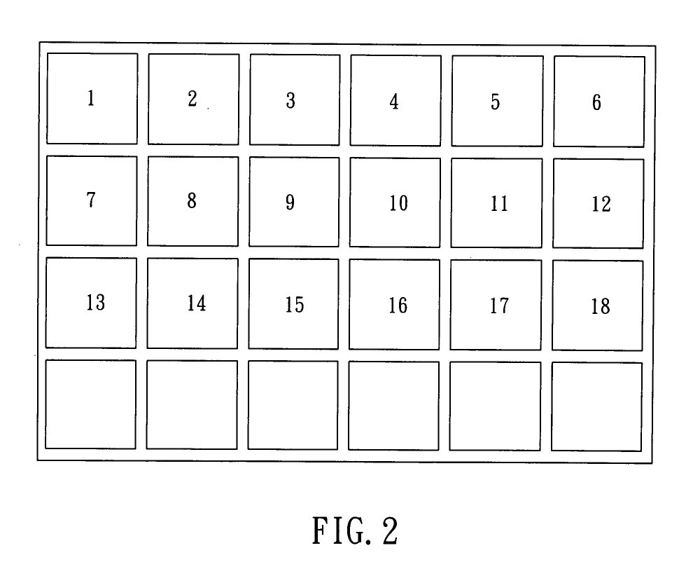

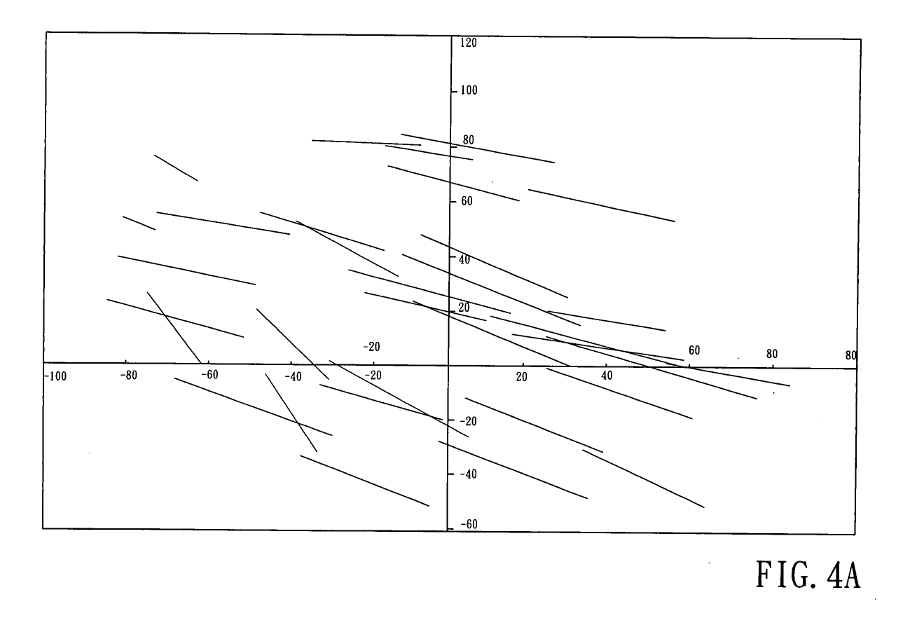

Please refer to FIG. 2, which is a schematic view of a color checker chart according to the present invention. By sampling 18 color patches out of the 24 color patches of the color checker chart of FIG. 2 for performing a C.T. distribution test on the same, a color patch as seen in FIG. 4A can be obtained.

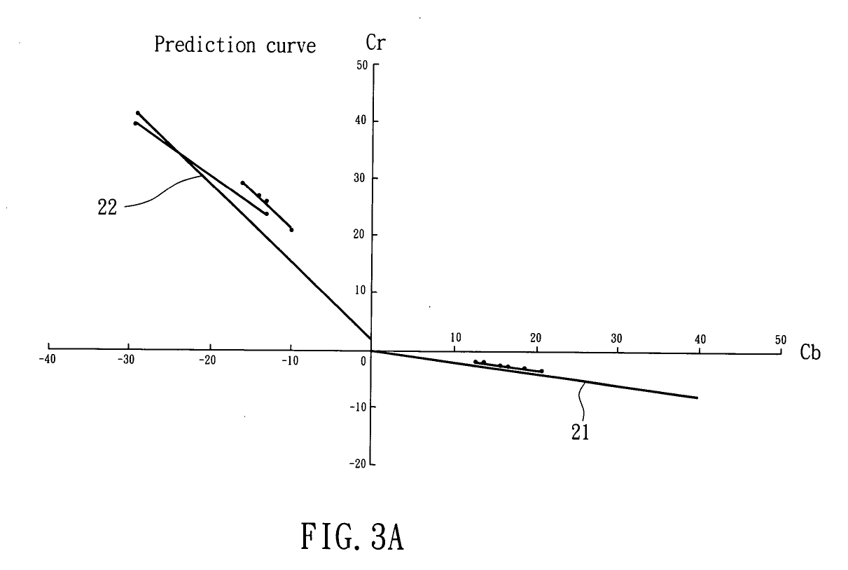

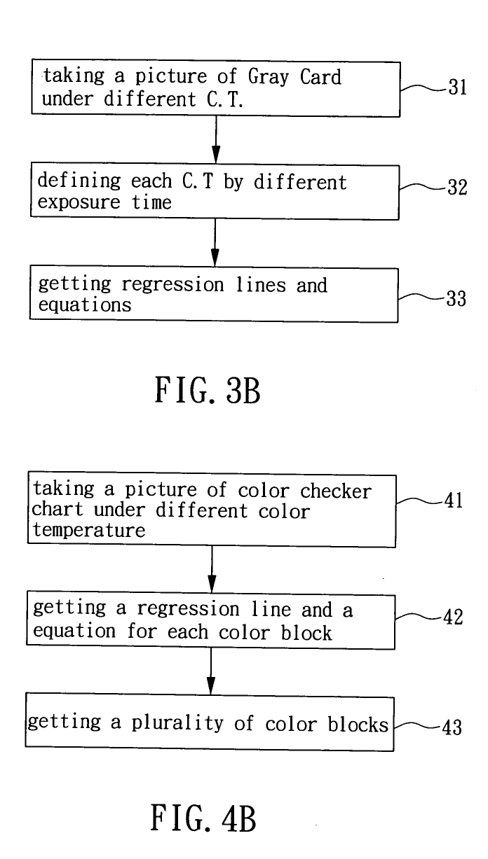

Please refer to FIG. 3A and FIG. 3B for a white point predictable curve and a method of acquiring the white point predictable curve, the method comprising the steps of:

taking a picture of Gray Card under different C.T. with reference to the five reference points, i.e. uses 2300K, 2800K, 4200K, 5000K and 6500K;

defining each C.T by different exposure time; and

getting regression lines and equations, which can be divided into a high-color temperature curve 21 and low-color temperature curve 22 for calibrating images of different C.T., wherein, the C.T of the second quadrant of FIG. 3A is lower and the C.T of the fourth quadrant of FIG. 3A is higher, that is, the color temperature is higher while Cb is larger and Cr is smaller, and the color temperature is lower while Cb is smaller and Cr is larger.

Please refer to FIG. 4A and FIG. 4B, which respectively is a color patch space of the present invention and the flow chart of acquiring the same. By applying the method of acquiring the regression lines and equation of FIG. 3A and FIG. 3B on the 18 different color patches of FIG. 2, the present invention can plot 18 sets of regression lines and equations on the color patch curve of FIG. 4A. The method of obtaining the color patch curve of FIG. 4A comprises the steps of:

taking a picture of color checker chart under different color temperature;

getting a regression line and a equation for each color patch according to the method of FIG. 3B;

getting a plurality of color patches.

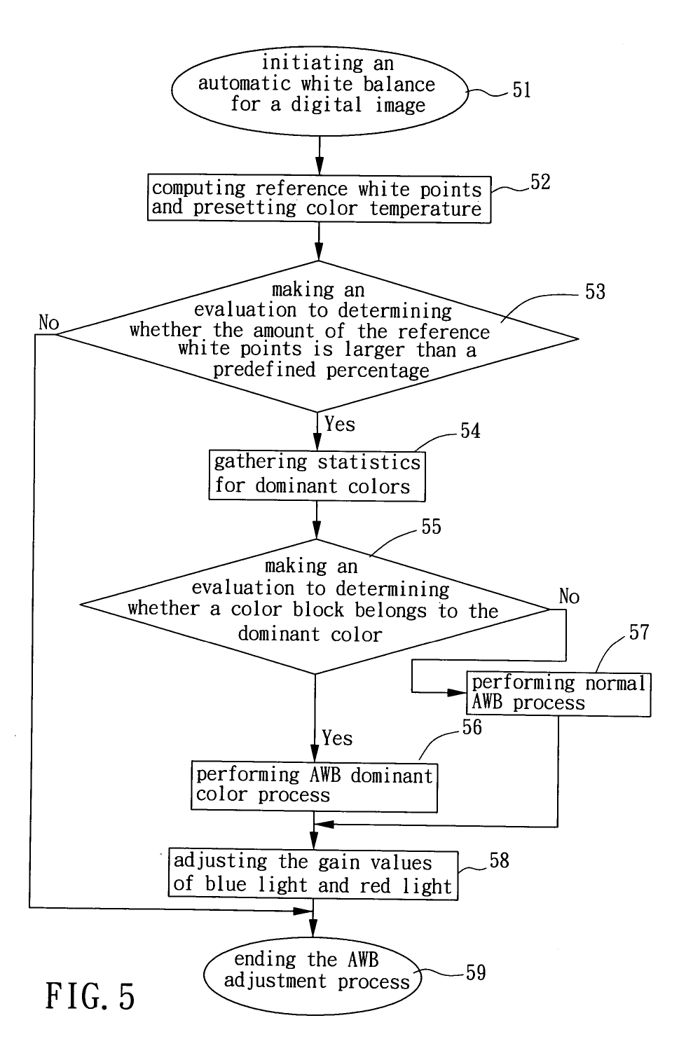

An automatic white balance process can be proceeded according to the flow chart shown in FIG. 5 after the color patch curve of FIG. 4A is acquired, and the process comprises the steps of:

step 51: initiating an automatic white balance for a digital image;

step 52: computing reference white points and presetting color temperature;

step 53: making an evaluation to determining whether the amount of the reference white points is larger than a predefined percentage; if so, goes to step 54, otherwise, goes to step 59;

step 54: gathering statistics for dominant colors;

step 55: making an evaluation to determining whether a color block belongs to the dominant color; if so, goes to step 56, otherwise, goes to step 57;

step 56: performing AWB dominant color process;

step 57: performing a normal AWB process as that shown the U.S. Pat. No. 6,069,972;
step 58: adjusting the gain values of blue light and red light;
step 59: ending the AWB adjustment process.

The forgoing method provided by the present invention is featuring by performing an automatic white balance on dominant colors of a digital image. For example, if a post box is the main object of a digital image to be filmed, the dominant color of the digital image is a blackish green color and a regression line and equation of the color block space most closer to the blackish green color is used to perform a white balance adjustment on the image. If the captured image is deviated to low color temperature, i.e. a reddish and yellowish image, the regression line of low color temperature is being used for comparison for adjusting the offset. On the other hand, if the captured image is deviated to high color temperature, i.e. a bluish image, the regression line of high color temperature is being used for comparison for adjusting the offset. The isometric shift is used for compensating the C.T. offset. The object of automatic white balance is achieved by adjusting the gain of blue light and red light.

However, from the structural characteristics and detailed disclosure of each embodiment according to the invention, it sufficiently shows that the invention has progressiveness of deep implementation in both objective and function, also has the application value in industry, and it is an application never seen ever in current market and, according to the spirit of patent law, the invention is completely fulfilled the essential requirement of new typed patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. a method for detecting and processing dominant color with automatic white balance, comprising steps of:
initiating an automatic white balance process for a digital image;
computing reference white points and presetting color temperature;
making an evaluation to determining whether the amount of the reference white points is larger than a predefined percentage of the digital image;
gathering statistics for a dominant color;
making an evaluation to determining whether a color patch is the dominant color;
performing an AWB dominant color process;
performing a normal AWB process;
adjusting gain values of blue light and red light; and
ending the automatic white balance process.

2. The method of claim 1, wherein the AWB dominant color process is performed when the color patch is the dominant color.

3. The method of claim 1, wherein the normal AWB process is performed when the color patch is not the dominant color

4. The method of claim 1, wherein the normal AWB process is the method using reference white points for detection and estimation.

5. The method of claim 1, the step of gathering statistics for a dominant color is performed when the amount of the reference white points is larger than the predefined percentage of the digital image.

6. The method of claim 1, the step of ending the automatic white balance process is performed when the amount of the reference white points is smaller than the predefined percentage of the digital image.

7. A method for acquiring a white point predictable curve, comprising steps of:
taking a picture of Gray Card under different color temperature;
defining each color temperature by different exposure time; and
getting a regression line and equation,

8. A method for acquiring a color patch space, comprising steps of:
taking a picture of color checker chart under different color temperature;
getting a regression line and a equation for each color patch;
getting a plurality of color patches.
